(19) United States
(12) Patent Application Publication
(10) Pub. No.: US 2011/0113099 A1
(43) Pub. Date: May 12, 2011

(54) METHOD FOR TRANSMITTING BUFFER MAP AND NETWORK THEREOF

(75) Inventors: Po-Yuan Teng, Kaohsiung City (TW); Hung-Yuan Chen, Hsinchu County (TW)

(73) Assignee: INDUSTRIAL TECHNOLOGY RESEARCH INSTITUTE, Hsinchu (TW)

(21) Appl. No.: 12/693,455

(22) Filed: Jan. 26, 2010

(30) Foreign Application Priority Data
Nov. 9, 2009 (TW) 98137929

(51) Int. Cl. G06F 13/00; G06F 15/16

(52) U.S. Cl. 709/205

(57) ABSTRACT

A method for transmitting buffer maps adapted in a peer-to-peer network comprising a plurality of peer nodes, and one or several super nodes are selected from the peer nodes, wherein when the buffer maps are transmitted in the peer-to-peer network, the super nodes are connected to each other, and each of the peer nodes is connected to one of the super nodes. First, each of the peer nodes transmits its buffer map to the super node connected thereto. Then, the super nodes exchanges the received buffer maps to each other, so as to synchronously update information of the buffer maps, and each of the super nodes updates a buffer map table recorded therein according to the exchanged buffer maps. Finally, each of the super nodes transmits the buffer map by the peer node connected thereto to the peer node.

### CROSS-REFERENCE TO RELATED APPLICATION

This application claims the priority benefit of Taiwan application serial no. 98137929, filed Nov. 9, 2009. The entirety of the above-mentioned patent application is hereby incorporated by reference herein and made a part of specification.

### BACKGROUND OF THE INVENTION

1. Field of Invention

The present disclosure generally relates to the peer-to-peer network, and more particularly to a method for transmitting the buffer map in the peer-to-peer network and the peer-to-peer network using the same.

2. Description of Prior Art

As the development of the computer and network technology, people live with the utilization of the network. The network users may share the files with each other via the connection of the network, and thus the peer-to-peer transmission technology is proposed. The peer-to-peer transmission software becomes the main stream software which is used to share the files with each other among the network users. The peer-to-peer transmission technology is still developed and evolved, and there are different architectures proposed.

Referring to FIG. 1A, FIG. 1A is a block diagram demonstrating the network architecture of the first generation of the peer-to-peer transmission technology. In FIG. 1A, when the peer node 101 wants to obtain some file, for example, the music file rock.mp3, the peer node 101 sends a request message to the server sever node 103, so as to ask the server node 103 which peer node has the music file rock.mp3. Next, the server node 103 sends a reply message to the peer node 101 to indicate which node owns the music file rock.mp3, for example, the peer node 102 owns the music file rock.mp3. Then, after the peer node 101 receives the reply message, the peer node 101 requests the peer node 102 to transmit the music file rock.mp3.

After introducing the network architecture of the first generation of the peer-to-peer transmission technology, referring to FIG. 1B, FIG. 1B is a block diagram demonstrating the network architecture of the second generation of the peer-to-peer transmission technology. In FIG. 1B, when the peer node 111 wants to obtain some file, for example, the music file rock.mp3, the peer node 111 send a request message to the peer nodes 112, 113, and 114 connected thereto, so as to ask whether the peer nodes 112, 113, and 114 own the music file rock.mp3. The peer nodes 112, 113, and 114 do not own the music file rock.mp3, and thus the peer nodes 113 and 114 pass the request message to the peer nodes 115 and 116 connected thereto. The peer node 116 owns the music file rock.mp3. Thus the peer node 116 sends the reply message to the peer node 113, and the peer node 113 passes the reply message to the peer node 111. Then the peer node 111 requests the peer nodes 116 to transmit the music file rock.mp3.

After introducing the network architecture of the second generation of the peer-to-peer transmission technology, referring to FIG. 1C, FIG. 1 is a block diagram demonstrating the network architecture of the third generation of the peer-to-peer transmission technology. In FIG. 1C, the sever node 124 has a table saving the relation of the hash function results and the link indices, so as to reduce the content saved in the sever node of the first generation of the peer-to-peer transmission technology. The link index is used to present the index of the peer node which the sever node 124 transmits the request message. For example, the link index is 3, and the request message is transmitted to the peer node 123.

When the peer node 121 wants to obtain some file, for example, the music file rock.mp3, the peer node 121 sends the request message to the sever node 124, so as to ask the server node 103 which peer node has the music file rock.mp3. The sever node 124 performs a hash function according to the request message, and find the link index according to the hash function result. For example, the link index found is 2, and then the sever node 124 passes the request message to the peer node 122. The peer node 122 is linked to the peer node 12X having the music file rock.mp3. Thus, the sever node 124 indicates the peer node 121 request the peer node 12X to transmit the music file rock.mp3 via the peer node 122.

Referring to FIG. 2, FIG. 2 is a block diagram demonstrating the tree push network architecture of the peer-to-peer transmission technology. In FIG. 2, the peer-to-peer network comprises a source node 200 and a plurality of peer nodes 201-209, wherein the tree topology can be a single tree topology (the topology presented by one of the solid line and the dot line) or a multiple tree topology (the topology presented by both of the solid line and the dot line). Each of the children nodes (i.e. peer nodes 201-209) of the source node 2 do not need to know that the other nodes have the data. In the architecture, the peer nodes 201 and 209 are merely responsible to receive the data transmitted by the source node and to pass the received data to the children nodes thereof. In addition, the multiple tree topology can prevent the problem that some peer nodes can not receive the data pushed by the source node when one of the peer nodes fails.

Referring to FIGS. 3A and 3B, FIG. 3A is a block diagram demonstrating the tree pull network architecture of the peer-to-peer transmission technology, and FIG. 3B a schematic diagram demonstrating the buffer maps of the peer node 301 and 303. The peer-to-peer network comprises a source node 300 and a plurality of peer nodes 301-304, wherein the peer nodes 301-304 are connected to each other and to the source node 300. In the architecture, each of the peer nodes must exchange the buffer map thereof, so as to know the data segments to be transmitted, wherein the exchange manner of each of the peer node is to exchange the buffer map every a specific time, to update the buffer map thereof, and to broadcast the updated buffer map to the peer nodes connected thereto.

For example, in FIG. 3B, the buffer map of the peer node 301 records that the peer node 301 has the second, fourth, and fifth data segments (where the indices are marked by bit 1), and does not have the first, third, and sixth data segments (where the indices are marked by bit 0). The buffer map of the peer node 303 records that the peer node 301 has the first, fourth, and fifth data segments, and does not have the second, third, and sixth data segments. Thus when the peer node 301 wants to obtain the second data segment, the peer node 301 can request the peer node 303 to transmit the second data segment according to the exchanged buffer maps. The peer node in the peer-to-peer network of FIG. 3A may have a transmission delay cause by the exchange of the buffer maps, the operation of the exchanged buffer map, and the transmission for requesting to transmit the packet.

The architectures of the mesh pull and tree push of the peer-to-peer transmission technologies have the different advantages and drawbacks, and thus some paper proposed a hybrid architecture combining the mesh-pull and tree-push of the peer-to-peer transmission technologies. In the he hybrid architecture combining the mesh-pull and tree-push of the peer-to-peer transmission technologies, the peer nodes can share and transmit the data by using the tree push architecture of the peer-to-peer transmission technology in a specific fix time, and when the peer node wants to play or use the file, the peer node can request the other peer node connected thereto to transmit the lacked data segment by using the mesh pull architecture of the peer-to-peer transmission technology.

In addition, a network using the network coding of the peer-to-peer transmission technology is further proposed recently. The peer-to-peer transmission technology multiplies multiple coefficients by the blocks in the data segment, and then adds the multiplied results, so as to obtain the encoded block, and to arbitrarily transmit the encoded block to each of the peer nodes. Each of the peer nodes receives can decode the blocks in the data segment according to the encoded blocks received, and can obtain the data segment according to the decoded blocks. The peer-to-peer transmission technology by using the network coding now has two kinds of the coding manners. One is the linear combination network coding, and the other one is random push with random network coding in live peer-to-peer streaming (abbreviated as R2).

Accordingly, the current peer-to-peer transmission technology has not improved the mechanism for exchanging the buffer maps, and that is because compared to the large amount of data of the multimedia stream, the traffic flow of the buffer map is little. However, in the real world, a plurality of hetero-apparatuses may use the peer-to-peer network to exchange the multimedia stream, and this environmental condition must be considered. For example, the scalable video coding becomes an important research issue. The scalable video coding compresses the video information into a basic layer and a plurality of enhancing layers, and then the number of the enhancing layers to be used is determined according to the bandwidth requirement and the resolution. In the scalable video coding, each of the compressed video encoding layers corresponds to a bit stream of a buffer map, and thus the bandwidth occupied by the buffer maps becomes significant. Therefore, how to reduce the network burden caused by the exchange of the buffer maps and how to exchange the buffer maps efficiently become an important issue.

### SUMMARY OF THE INVENTION

An exemplary embodiment of the present disclosure provides a method for transmitting buffer maps which is adapted in the peer-to-peer network. In the method for transmitting buffer maps, the nodes having the larger bandwidths and computation abilities (defined as the super nodes) are used to manage the buffer maps and transmit the buffer maps to the children nodes thereof (i.e. the peer nodes which act as the children nodes of the super nodes), so as to reduce the transmission of the non-useful information. In addition, an exemplary embodiment of the present disclosure further provides another method for transmitting the buffer maps, wherein the buffer map of each of the peer nodes merely records a peer node identification, a start index of the data segment, and an offset index map representing the lacked data segments. Thus the peer node in the peer-to-peer network using the method for transmitting the buffer maps can reduce the size of the buffer map.

An exemplary embodiment of the present disclosure provides a method for transmitting buffer maps which is adapted in a peer-to-peer network. The peer-to-peer network comprises a plurality of peer nodes, and one or several super nodes are selected from the peer nodes, wherein when the buffer maps are transmitted in the peer-to-peer network, the super nodes are connected to each other, and each of the peer nodes is connected to one of the super nodes. First, each of the peer nodes transmits its buffer map to the super node connected thereto. Then, the super nodes exchanges the received buffer maps to each other, so as to synchronously update information of the buffer maps, and each of the super nodes updates a buffer map table recorded therein according to the exchanged buffer maps. Finally, each of the super nodes transmits the buffer map by the peer node connected thereto to the peer node.

An exemplary embodiment of the present disclosure provides a peer-to-peer network. The peer-to-peer network comprises a plurality of peer nodes used to share a plurality of data segments. One or several super nodes are selected from the peer nodes. When the buffer maps are transmitted in the peer-to-peer network, part or all of the super nodes are connected to each other, and each of the peer nodes is connected to one of the super nodes. When the data segments are transmitted in the peer-to-peer network, part or all of the peer nodes are connected to each other, part or all of the super nodes are connect to each other, and the peer node connected to at least one of the super nodes.

Accordingly, the method for transmitting the buffer maps and the peer-to-peer network provided in an exemplary embodiment of the present disclosure can reduce the transmission of the non-useful information when the buffer maps are transmitted in the peer-to-peer network, so as to save the network bandwidth.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram demonstrating the network architecture of the first generation of the peer-to-peer transmission technology.

FIG. 1B is a block diagram demonstrating the network architecture of the second generation of the peer-to-peer transmission technology.

FIG. 1C is a block diagram demonstrating the network architecture of the third generation of the peer-to-peer transmission technology.

FIG. 2 is a block diagram demonstrating the tree push network architecture of the peer-to-peer transmission technology.

FIG. 3A is a block diagram demonstrating the tree push network architecture of the peer-to-peer transmission technology.

FIG. 3B a schematic diagram demonstrating the buffer maps of the peer node 301 and 303.

FIG. 4 is a schematic diagram demonstrating the buffer map of the peer node in the peer-to-peer network at different time.

FIG. 5 is a schematic diagram demonstrating the format of the buffer map transmitted in the peer-to-peer network according to an exemplary embodiment of the present disclosure.

FIG. 6 is a flow chart demonstrating the method for transmitting buffer maps according to an exemplary embodiment of the present disclosure.

FIG. 7A is a schematic diagram demonstrating the topology of the peer-to-peer network when the data segments are transmitted the peer-to-peer network according to an exemplary embodiment of the present disclosure.

FIG. 7B is a schematic diagram demonstrating the topology of the peer-to-peer network when the buffer maps are transmitted the peer-to-peer network according to an exemplary embodiment of the present disclosure.

FIG. 7C is a schematic diagram demonstrating the topology of the peer-to-peer network when the data segments are transmitted the peer-to-peer network according to another exemplary embodiment of the present disclosure.

FIG. 8 is a schematic diagram demonstrating the buffer map table stored in the super node according to an exemplary embodiment of the present disclosure.

FIG. 9 is a flow chart demonstrating the method for transmitting buffer maps according to another exemplary embodiment of the present disclosure.

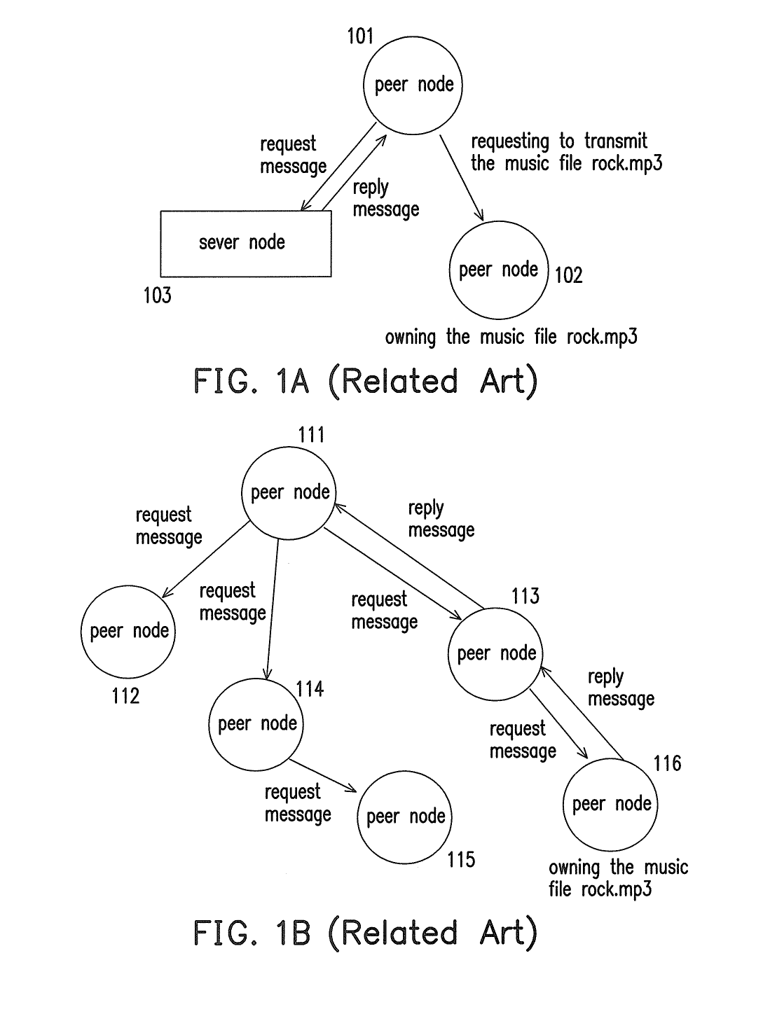

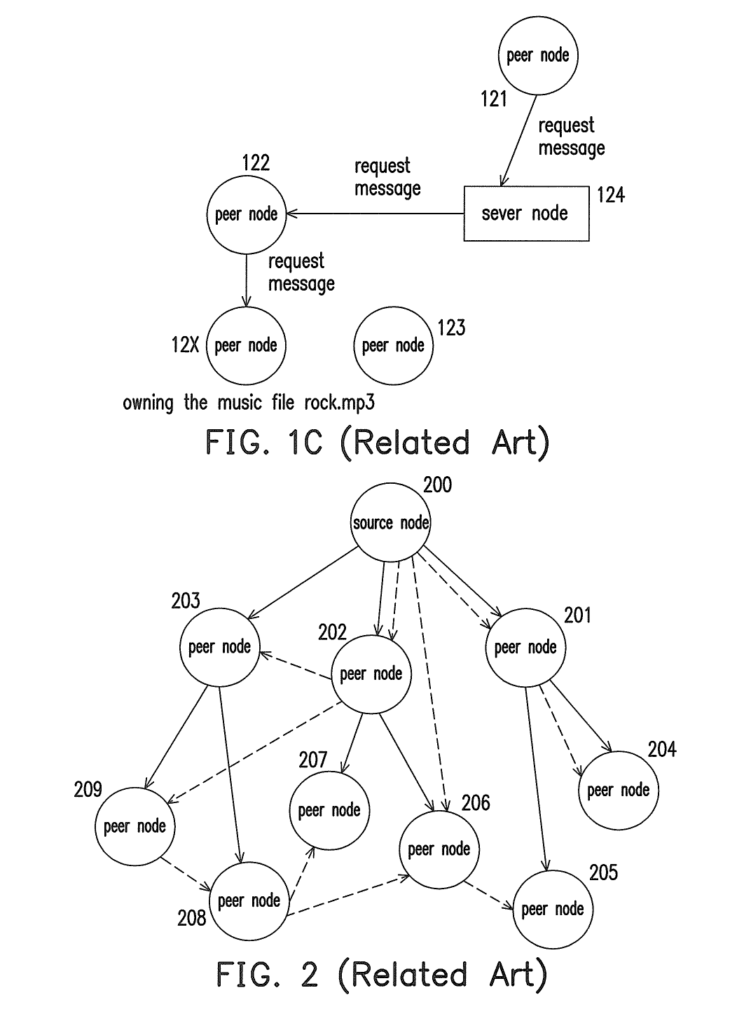

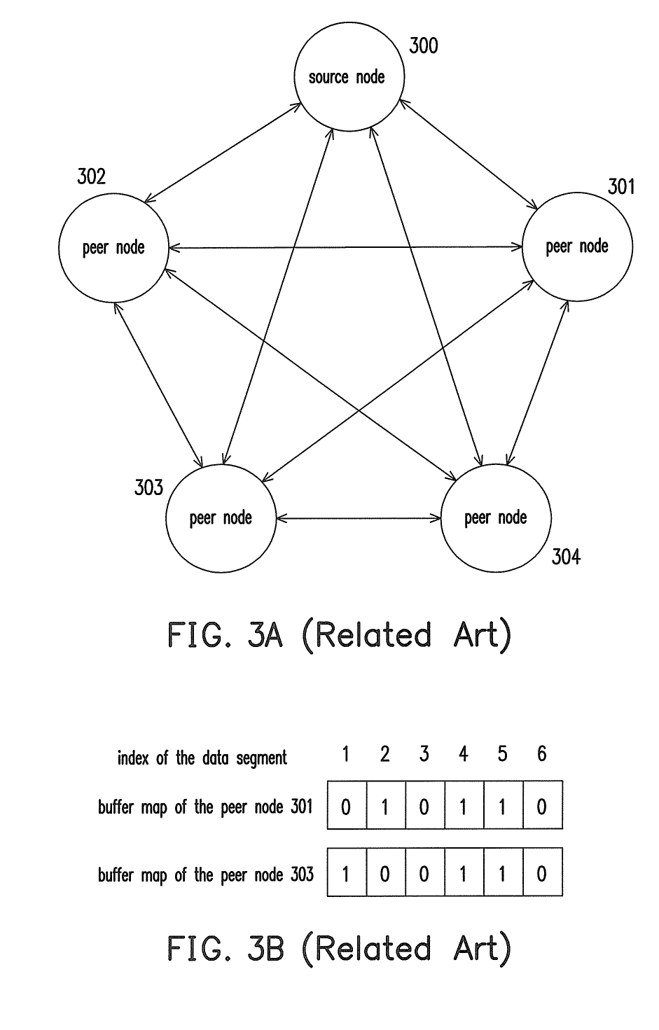

### DESCRIPTION OF THE EMBODIMENTS

Reference will now be made in detail to the present preferred embodiment of the invention, examples of which are illustrated in the accompanying drawings. Wherever possible, the same reference numbers are used in the drawings and the description to refer to the same or like parts.

As the communication technology develops very fast, there are more and more hereto-apparatuses connecting to the internet, such as a netbook, a mobile internet device (abbreviated as MID), an ultra-mobile personal computer (abbreviated as UMPC), a smart phone, and so on. In the future, the computation abilities and the network transmission speeds of these hereto-apparatuses will be strong as the modern PCs. The peer-to-peer network application in the modern PCs which develops very fast will be applied in theses hereto-apparatuses. The exchange of the buffer maps which is the required data transmission in the peer-to-peer network is carried out in the mesh network architecture. An exemplary embodiment of the present disclosure provides a method for transmitting buffer maps, so as to efficiently save the network bandwidth, and the method is adapted in the mesh push peer-to-peer network which is the most outstanding network architecture in the peer-to-peer networks.

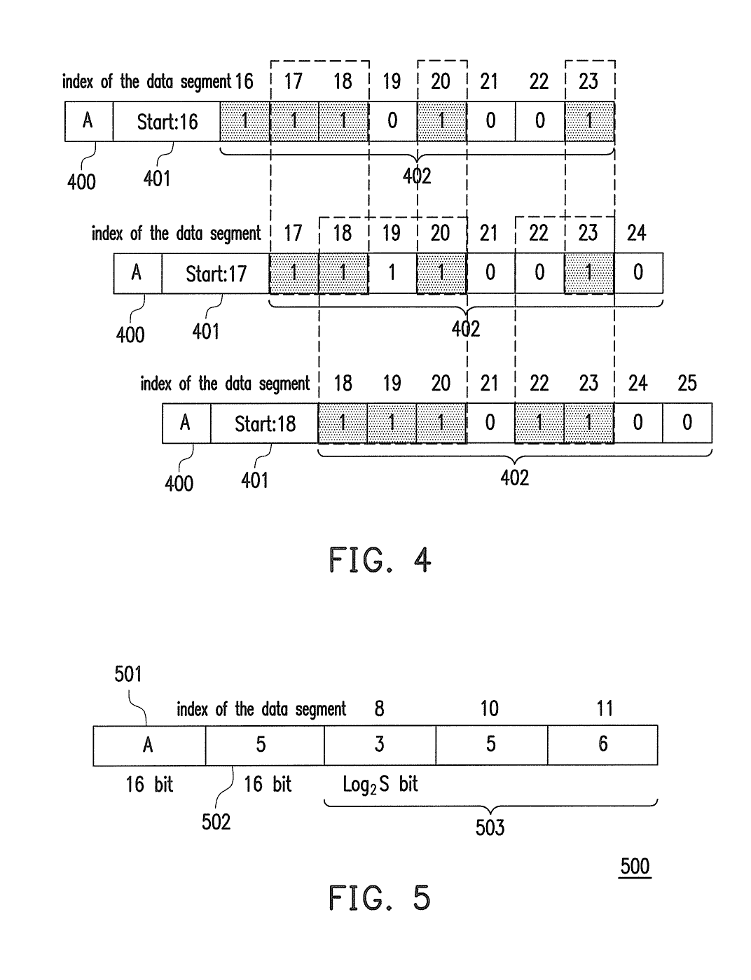

Referring to FIG. 4, FIG. 4 is a schematic diagram demonstrating the buffer map of the peer node in the peer-to-peer network at different time. Each of the buffer maps comprises a peer node identification 400, a start index of the data segment 401, and a bit map 402, wherein the length of the bit map 402 is correlated to the size of the playback buffer of the peer node. The peer node 400 represents the appellation of the peer node in the peer-to-peer network, for example the appellation of the peer node in FIG. 4 is peer node A. The start index of the data segment 401 presents an index of the first one data segment recorded in the first buffer map. The bit map 402 presents the data segments owned by the peer node (presented by bit 1) and the data segment lacked by the peer node (presented by bit 0). For example, one start index of the data segment 401 of buffer map is 16, and the first bit of the bit map 402 is 1, meaning that the peer node A owns the sixteenth data segment. For another example, in FIG. 4, a start index of the data segment 401 of another buffer map 401 is 18, and the fourth bit of the bit map 402 is 0, meaning that the peer node A lacks the 21^{th} data segment.

In FIG. 4, when the full rate is increasing higher, it is obvious to see that the bit map has the more valid and non-useful information. For example, at time t1, the buffer map records that the peer node A owns the 17^{th}, 18^{th}, 20^{th}, and 23^{th} data segments, but at time t2, the buffer map repeatedly records that the peer node A owns the 17^{th}, 18^{th}, 20^{th}, and 23^{th} data segments. For another example, at time t2, the buffer map records that the peer node A owns the 18^{th}, 19^{th}, 20^{th}, 22^{th} and 23^{th} data segments, but at time t3, the buffer map repeatedly records that the peer node A owns the 18^{th}, 19^{th}, 20^{th}, 22^{th} and 23^{th} data segments. Thus, if the full rate of the current buffer map is 80%, the buffer amp next transmitted merely will have about 20% valid and useful information.

In addition, the conventional peer-to-peer network also has a problem of the buffer map cheating. When the bits in the bit map of a buffer map transmitted by a peer node are all zero, the peer node does not provide any data segment to the other peer nodes, but continuously receives the data segments from the other peer nodes, thus causing the waste of the bandwidth and the violation of the object for sharing the files.

To reduce the transmission of the non-useful information, an exemplary embodiment of the present disclosure provides a peer-to-peer network, and the buffer maps used in the peer-to-peer network are different from the conventional buffer maps. Referring to FIG. 5, FIG. 5 is a schematic diagram demonstrating the format of the buffer map transmitted in the peer-to-peer network according to an exemplary embodiment of the present disclosure. The buffer map 500 comprises a peer node identification 501, a start index of the data segment 501, and an offset indices map 503.

The peer node identification 501 presents an appellation of the peer node in the peer-to-peer network, for example the peer node in FIG. 5 is the peer node A. The start index of the data segment 502 presents an index of the first one data segment recorded in the first buffer map. For example, in FIG. 5, the start index of the data segment 502 is 5, and this means the indices of the data segments recorded by the buffer map 500 start from fifth. The offset index map 503 records at least one offset index of the data segment lacked by the peer node A, wherein the offset index is the offset value between the start index of the data segment and the index of the lacked data segment. For example, in FIG. 5, the offset index map 503 has three offset indices which are respectively 3, 5, and 6, meaning that the peer node A lacks the 8^{th}, 10^{th}, and 11^{th} data segments.

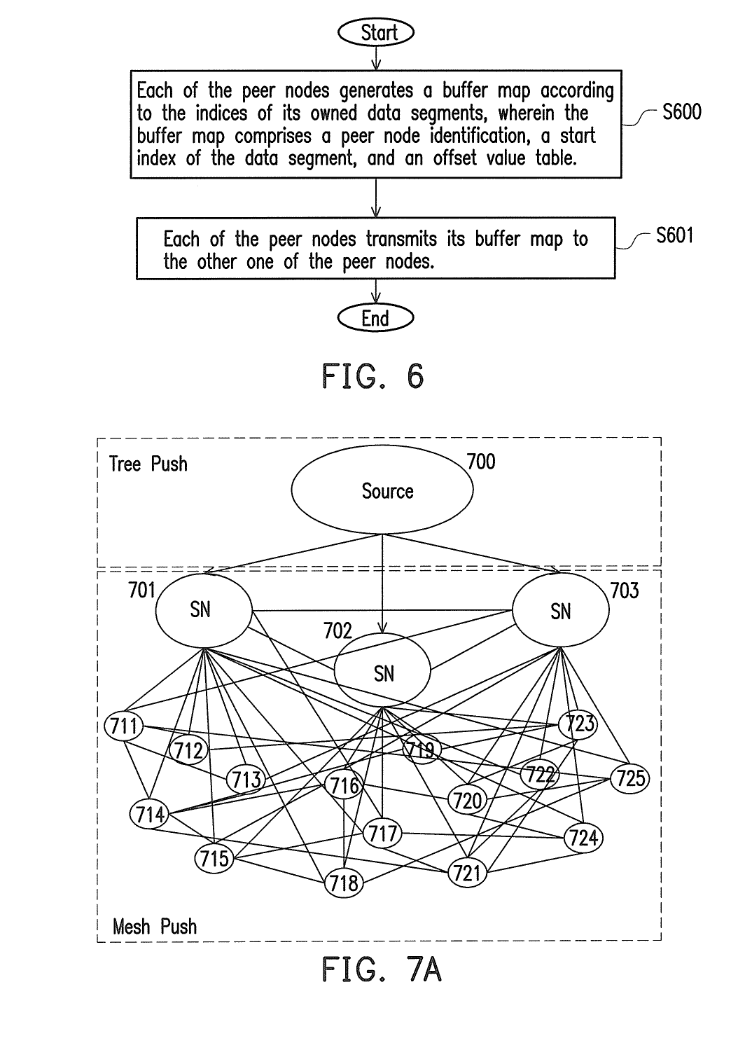

Next, referring to FIG. 6, FIG. 6 is a flow chart demonstrating the method for transmitting buffer maps according to an exemplary embodiment of the present disclosure. The method for transmitting buffer maps is adapted in the mesh peer-to-peer network or the other peer-to-peer networks having to transmitting the buffer maps, wherein the peer-to-peer network comprises a plurality of peer nodes. The peer nodes share the data segments with each other. It is noted that, the peer-to-peer network executes the method for transmitting buffer maps in FIG. 6 every a time period, or the user can command the peer-to-peer network to execute the method for transmitting buffer maps in FIG. 6 by force.

First, in step S600, each of the peer nodes generates a buffer map according to the indices of its owned data segments, wherein the buffer map comprises a peer node identification, a start index of the data segment, and an offset value table. The format of the buffer map herein is the same as that of the buffer map shown in FIG. 5, thus not being described. Next, in step S601, each of the peer nodes transmits its buffer map to the other one of the peer nodes.

In the conventional mesh pull peer-to-peer network, the buffer map of the each of the peer nodes reveals the information of “which of the peer nodes have my wanted data segment”, and thus each of the peer nodes can determine which one of the peer nodes is requested to transmit its lacked data segment to it according to the information conveyed by the buffer map. However, in the mesh push peer-to-peer network, each of the peer nodes consider the information of “which of the peer nodes lack of the data segment”, and then the peer node can select one of the peer nodes lacking of the data segment according to the buffer map, and transmit the data segment to the selected peer node.

Another exemplary embodiment of the present disclosure provides a method for transmitting buffer maps, the method for transmitting the buffer maps is not the same as the conventional one which the peer node broadcasts the buffer map to all of its neighboring peer nodes. By contrast, in the method for transmitting buffer maps in the exemplary embodiment of the present disclosure, each of the peer nodes transmits its buffer map to the super node connected thereto.

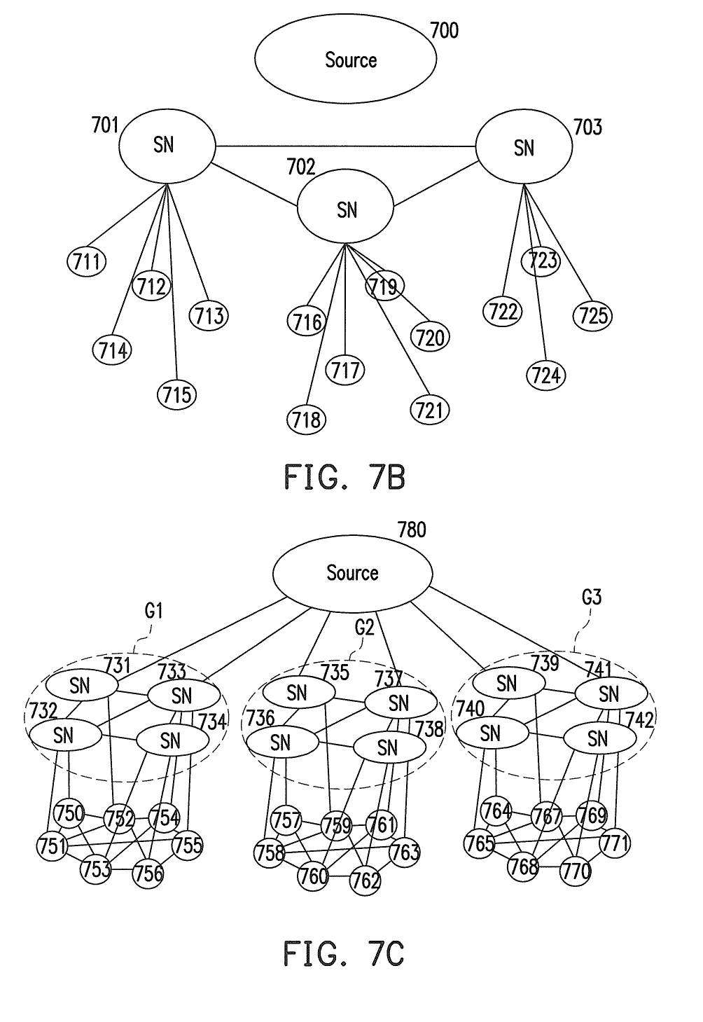

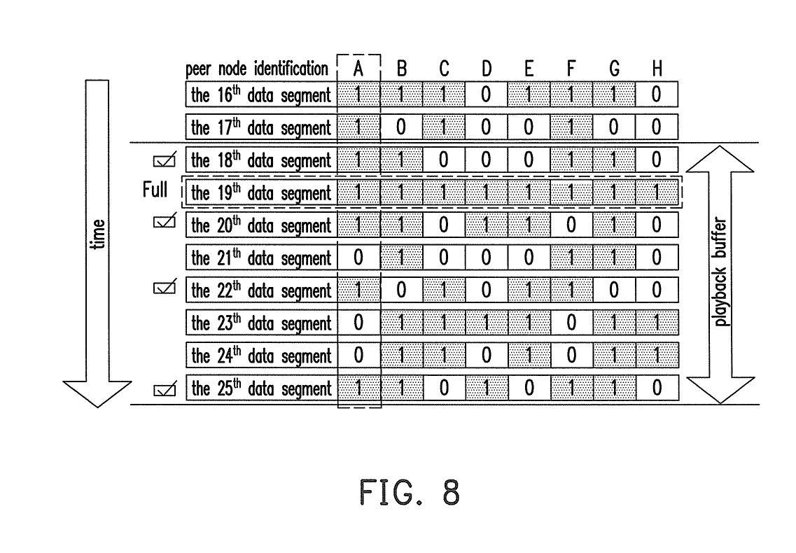

Referring to FIGS. 7A and 7B, FIG. 7A is a schematic diagram demonstrating the topology of the peer-to-peer network when the data segments are transmitted the peer-to-peer network according to an exemplary embodiment of the present disclosure, and FIG. 7B is a schematic diagram demonstrating the topology of the peer-to-peer network when the buffer maps are transmitted the peer-to-peer network according to an exemplary embodiment of the present disclosure. In FIG. 7A, when the data segments are transmitted the peer-to-peer network, the topology formed by the source node 700 and the super nodes 701-703 is the tree topology, and the topology formed by the super nodes 701-703 and the peer nodes 711-725 is mesh topology, wherein the super nodes 701-703 are also peer nodes. The peer-to-peer network can use the super node selection algorithm to select one or several super node from the peer nodes. In the exemplary embodiment the peer nodes 701-703 are selected as the super nodes. To put it more concretely, the source node 700 and the super nodes 701-703 form the tree push peer-to-peer network, and the super nodes 701-703 and the peer nodes 711-725 form the mesh push peer-to-peer network.

In FIG. 7B, when the buffer maps are transmitted the peer-to-peer network, the topology formed by the super node 701 and the peer nodes 701-715 is the tree topology, the topology formed by the super node 702 and the peer nodes 716-720 is the tree topology, the topology formed by the super node 703 and the peer nodes 721-725 is the tree topology, and the super nodes 701-703 are connected to each other. The peer nodes 711-725 transmit their owned buffer maps to the super nodes connected thereto. Then the super nodes 701-703 exchange the owned buffer maps with each other, so as to update the buffer maps thereof to the latest states. Next, the super nodes 701-703 transmits the buffer maps required by the peer nodes 711-725 to the peer nodes 711-725 managed by the super nodes 701-703.

In short, the super nodes 701-703 are responsible to collect the information of all buffer maps, so as to establish the buffer map tables. The buffer map table records the current distribution of the data segments in the peer nodes. Next, the super nodes 701-703 transmit information of the buffer maps required by their children nodes (i.e. the peer nodes connected thereto) to each of their children nodes according to the buffer maps of their children nodes. It is further noted that, the buffer map used in the peer-to-peer network in FIG. 7B can be the conventional buffer map (such as the buffer map in FIG. 4), or the buffer map provided by the exemplary embodiment of the present disclosure (such as the buffer map in FIG. 5). However, based upon the following and foregoing reasons, it can be seen that when the peer-to-peer network FIG. 7B uses the buffer map in FIG. 5, the transmission efficiency is improved much.

In addition, when the data segments are transmitted in the peer-to-peer network of FIG. 7A, the topology of the peer-to-peer network is not used to limit the present disclosure. Referring to FIG. 7C, FIG. 7C is a schematic diagram demonstrating the topology of the peer-to-peer network when the data segments are transmitted the peer-to-peer network according to another exemplary embodiment of the present disclosure. In the exemplary embodiment, the source node 780 is connected to the super nodes 731-742. The super nodes 731-734 are connected to each other, forming a group G1. The peer nodes 750-756 under the group G1 are connected to each other, and connected to the super nodes 731-734. In the similar manner, the super nodes 735-738 are connected to each other, forming a group G2. The peer nodes 757-763 under the group G2 are connected to each other, and connected to the super nodes 735-738. The super nodes 739-742 are connected to each other, forming a group G3. The peer nodes 764-771 under the group G3 are connected to each other, and connected to the super nodes 739-742. In other words, the super nodes 731-742 form a plurality of groups of the mesh topology architectures.

Referring to FIG. 8, FIG. 8 is a schematic diagram demonstrating the buffer map table stored in the super node according to an exemplary embodiment of the present disclosure. Taking the peer node A as the example, not all information of the buffer maps corresponding to peer A is useful. First, some of the information is expired, and the info illation of the buffer map of the data segments which is not saved in the playback buffer is no more needed. Second, if some data segment is owned by all of the peer nodes, such as the 19^{th} data segment, the information of the buffer map of the data segment is not needed to be transmitted. Third, based on the push peer-to-peer network, when a peer node lacks of some data segment, the thing for telling the peer node which of the nodes also lack of the data segment is unnecessary. That is because the peer node can not transmit the lacked data segment to the other peer nodes.

Assuming the super node of the peer node A only transmits the buffer map which has the information of “some peer node lacks of the 18^{th}, 20^{th}, 22^{th}, and 25^{th} data segments” to the peer node A, the information of the transmitted buffer map only comprises the information of “which of the peer nodes need these data segments” (i.e. the part corresponding the bit 1 in FIG. 8). For example, the super node of the peer node A merely tells the peer node A that peer node C, D, E, and H need the 18^{th} data segment, and that means, in the method for transmitting the buffer maps provided by an exemplary embodiment of the present disclosure, the more the full rate of the playback buffer is, the less the information of the buffer map to be transmitted is.

However, when the network coding technology is applied to the peer-to-peer network, the third point mentioned above is not completely correct, that is because the peer nodes transmit the combination of data blocks (one part of the data segment). This means that even the peer node does not receive the information of the complete data segment, there is some information of the data segment is useful for the other peer nodes.

To solve the problem, the super node further can randomly insert the conventional buffer maps in the all buffer maps (i.e. this means the buffer maps comprises the conventional buffer maps and the buffer maps as shown in FIG. 5). Thus the entire peer-to-peer network can be more stable. Another problem is that all of the peer nodes have no complete data segment to provide to the peer-to-peer network (i.e. the full rate is very low) when the peer-to-peer network is initially established. To solve this problem, a mechanism for dynamically regulating the ratio of the conventional buffer maps and the buffer maps as shown in FIG. 5 is provided. When the full rate is low, the number of the conventional buffer maps is increasing. When the full rate is high, the number of the conventional buffer maps is decreasing.

Please referring to FIGS. 7A and 7B again, after each of the super nodes transmits the buffer map required by the managed peer nodes to the managed peer nodes, each of the peer nodes transmits its owned data segment the other peer nodes lacking the data segment thereof. It is noted that, the peer-to-peer network can adapt the random push manner, such as R². Each of the peer nodes can randomly select one of the other nodes, and transmit the data segment to the selected peer node. Although the manner for selecting one of the peer nodes mentioned above is to select the peer node randomly, the manner for selecting one of the peer nodes in present disclosure is not limited thereto, and the manner for can be designed by the user according to the condition of the peer-to-peer network.

In the exemplary embodiment, the property of “random” can be utilized efficiently, for example, when the peer node A is told that the peer nodes C, D, E, H need the 18^{th} data segment, the peer node A can randomly select one of the peer nodes C, D, E, H, and transmit 18^{th} data segment to the selected peer node. In addition, to efficiently reduce the computation complexity and network flow of the peer node, the manner for selecting one of the peer nodes can be executed by the super node. When the super node is indicated that the peer node A needs to transmit the 18^{th} data segment to the peer nodes C, D, E, H, the super node pre-selects one of the peer nodes C, D, E, H, and then tells the pre-selection result to the peer node A.

In addition, when the peer-to-peer network adapts the network coding technology, the frequency that the peer nodes exchanges the data segments is higher than the frequency that peer nodes exchanges exchange the buffer maps. For example, the size of the data segment is 50 KB (Kilo-Bytes), one data segment can be divided into 50 data blocks, and each of the data segment is 1 KB. Then each of the peer nodes theoretically can transmit 128 data blocks when an upload bandwidth of 128 KB/S (Kilo-Bytes/Second) is provided.

If the playback buffer is able to save 64 data segments, it is obviously enough that each of the peer nodes transmits the data segment to select peer node one time. Even though the same one data segment can generate different data blocks and push the data blocks to the same peer node, the system is not stable due the deficiency of the randomness. To solve the problem, the super node can adds the number of the pre-selected peer nodes corresponding to the data segment for his children nodes (i.e. the peer nodes connected thereto), the number of the pre-selected peer nodes is determined according to the full rate and the number of the data segments in which the playback buffer can save.

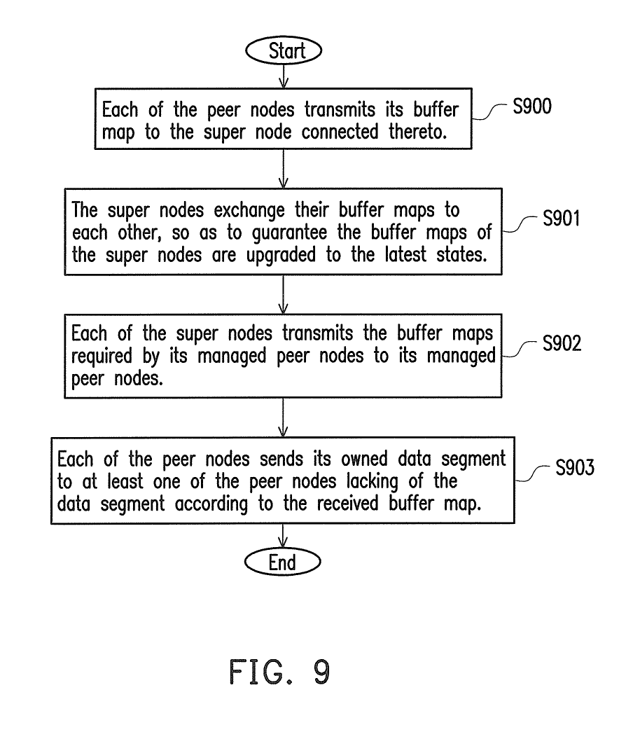

Referring to FIG. 9, FIG. 9 is a flow chart demonstrating the method for transmitting buffer maps according to another exemplary embodiment of the present disclosure. The method for transmitting buffer maps is adapted in the peer-to-peer network. The peer-to-peer network has a plurality of super nodes and peer nodes, wherein when the buffer maps are transmitted in the peer-to-peer network, each of the peer nodes is connected to one of the super nodes. In other words, each of the super nodes has a plurality of children node (i.e. the peer nodes connected thereto), and each of the peer nodes has one super node as its father node (i.e. the topology as shown in FIG. 7B). First, in step S900, each of the peer nodes transmits its buffer map to the super node connected thereto. Next, in step S901, the super nodes exchange their buffer maps to each other, so as to guarantee the buffer maps of the super nodes are upgraded to the latest states. Then in step S902, each of the super nodes transmits the buffer maps required by its managed peer nodes to its managed peer nodes.

In step S903, each of the peer nodes sends its owned data segment to at least one of the peer nodes lacking of the data segment according to the received buffer map. Each of the peer nodes may transmit its data segment to all of the peer nodes lacking of the data segment thereof according to the received buffer map. Each of the peer nodes may select one the peer nodes lacking of the data segment thereof, and transmit the data segment to the selected peer node, or each of the peer nodes query the super node connected thereto to select one the peer nodes lacking of the data segment thereof, and then transmit the data segment to the selected peer node. In addition, under the condition that the peer-to-peer network adapts the network coding technology, the peer node may obtain the buffer maps of the peer nodes lacking of its owned data segment, and then each of the peer nodes selects at one of the peer node lacking of the its owned data segment, and sends its owned data segment to the selected peer node.

To sum up, an exemplary embodiment of the present disclosure provides the method for transmitting the buffer map, wherein the buffer map each of the peer nodes only records the peer node identification, the start index of the data segment, and start index of the data segment, and the offset index map representing the lacked data segments. Thus the peer node in the peer-to-peer network using the method for transmitting the buffer maps can reduce the size of the buffer map. In addition, an exemplary embodiment of the present disclosure provides the method for transmitting the buffer map. In the method for transmitting buffer maps, the nodes in the hierarchical having the larger bandwidths and computation abilities are used to manage the buffer maps and transmit the buffer maps to the children nodes thereof (i.e. the peer nodes which act as the children nodes of the super nodes), so as to reduce the transmission of the non-useful information, wherein the buffer map can be the conventional buffer map or the buffer map provided by the exemplary embodiment of the present disclosure.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for transmitting buffer maps, adapted in a peer-to-peer network, wherein the peer-to-peer network comprises a plurality of peer nodes, and one or several super nodes are selected from the peer nodes, the peer nodes share a plurality of data segments with each other, wherein when the buffer maps are transmitted in the peer-to-peer network, the super nodes are connected to each other, and each of the peer nodes is connected to one of the super nodes, the method for transmitting the buffer maps comprising:
each of the peer nodes transmits its buffer map to the super node connected thereto;
the super nodes exchanges the received buffer maps to each other, so as to synchronously update information of the buffer maps, and each of the super nodes updates a buffer map table recorded therein according to the exchanged buffer maps; and
each of the super nodes transmits the buffer map by the peer node connected thereto to the peer node.

2. The method for the transmitting buffer maps as cited in claim 1, further comprising:
each of the peer nodes transmits the data segment thereof to at least one of the peer nodes requiring the data segment according to buffer map received from the super node.

3. The method for the transmitting buffer maps as cited in claim 2, wherein each of the peer nodes selects one of the peer nodes requiring the data segment thereof, and transmits the data segment to the selected peer node.

4. The method for the transmitting buffer maps as cited in claim 2, wherein each of the peer nodes relies on the super node connected thereto to select one of the peer nodes requiring the data segment thereof, and transmits data segment to the peer node.

5. The method for the transmitting buffer maps as cited in claim 2, wherein the peer-to-peer network uses a network coding technology.

6. The method for the transmitting buffer maps as cited in claim 5, the peer node obtains the buffer maps of the other peer nodes from the super nodes connected thereto, selects at least one of the peer nodes requiring the data segment thereof, and transmits the data segment to the selected peer node.

7. The method for the transmitting buffer maps as cited in claim 5, wherein the buffer maps comprise a plurality of first buffer maps, a plurality of second buffer maps, or the first and second buffer maps, wherein the first buffer map comprises a peer node identification, a start index of the data segment, and a bit map, and the second buffer map comprises a peer node identification, a start index of the data segment, and an offset index map.

8. The method for the transmitting buffer maps as cited in claim 7, wherein the peer node identification of the first buffer map is used to present an appellation of the peer node in the peer-to-peer network, and the start index of the data segment of the first buffer map is used to present an index of the first one data segment recorded in the first buffer map, the bit map of the first buffer map is used to record whether the peer node owns the data segments corresponding to the indices of the data segments presented in the bit map.

9. The method for the transmitting buffer maps as cited in claim 7, wherein the peer node identification of the second buffer map is used to present an appellation of the peer node in the peer-to-peer network, and the start index of the data segment of the second buffer map is used to present an index of the first one data segment recorded in the first buffer map, the offset index map of the second buffer map comprises at least one offset index of the data segment, and the index of the data segment required by the peer node is the start index of the data segment plus the offset index of the data segment.

10. The method for the transmitting buffer maps as cited in claim 2, wherein when each of the peer nodes transmits the data segment thereof to the at least one of the peer nodes requiring the data segment thereof, the peer nodes are connected to each other, and the super nodes are connected to each other, and the peer nodes are connected to the super nodes.

11. A peer-to-peer network, comprising:
a plurality of peer nodes, used to share a plurality of data segments;
wherein one or several super nodes are selected from the peer nodes; when the buffer maps are transmitted in the peer-to-peer network, part or all of the super nodes are connected to each other, and each of the peer nodes is connected to one of the super nodes; when the data segments are transmitted in the peer-to-peer network, part or all of the peer nodes are connected to each other, part or all of the super nodes are connect to each other, and the peer node connected to at least one of the super nodes.

12. The peer-to-peer network as cited in claim 11, wherein when the buffer maps are transmitted in the peer-to-peer network, each of the peer nodes transmits its buffer map to the super node connected thereto, the super nodes connected thereto exchanges the received buffer maps to each other, so as to synchronously update information of the buffer maps, each of the super nodes updates a buffer map table recorded therein according to the exchanged buffer maps, and each of the super nodes transmits the buffer map by the peer node connected thereto to the peer node.

13. The peer-to-peer network as cited in claim 12, wherein each of the peer nodes transmits the data segment thereof to at least one of the peer nodes requiring the data segment according to buffer map received from the super node.

14. The peer-to-peer network as cited in claim 13, wherein each of the peer nodes selects one of the peer nodes requiring the data segment thereof, and transmits the data segment to the selected peer node.

15. The peer-to-peer network as cited in claim 13, wherein each of the peer nodes relies on the super node connected thereto to select one of the peer nodes requiring the data segment thereof, and transmits data segment to the peer node.

16. The peer-to-peer network as cited in claim 13, wherein the peer-to-peer network uses a network coding technology.

17. The peer-to-peer network as cited in claim 16, wherein the peer node obtains the buffer maps of the other peer nodes from the super nodes connected thereto, selects at least one of the peer nodes requiring the data segment thereof, and transmits the data segment to the selected peer node.

18. The peer-to-peer network as cited in claim 17, wherein the buffer maps comprise a plurality of first buffer maps, a plurality of second buffer maps, or the first and second buffer maps, wherein the first buffer map comprises a peer node identification, a start index of the data segment, and a bit map, and the second buffer map comprises a peer node identification, a start index of the data segment, and a offset index map.

19. The peer-to-peer network as cited in claim 18, wherein the peer node identification of the first buffer map is used to present an appellation of the peer node in the peer-to-peer network, and the start index of the data segment of the first buffer map is used to present an index of the first one data segment recorded in the first buffer map, the bit map of the first buffer map is used to record whether the peer node owns the data segments corresponding to the indices of the data segments presented in the bit map.

20. The peer-to-peer network as cited in claim 18, wherein the peer node identification of the second buffer map is used to present an appellation of the peer node in the peer-to-peer network, and the start index of the data segment of the second buffer map is used to present an index of the first one data segment recorded in the first buffer map, the offset index map of the second buffer map comprises at least one offset index of the data segment, and the index of the data segment required by the peer node is the start index of the data segment plus the offset index of the data segment.
